(19) United States
(12) Patent Application Publication
(10) Pub. No.: US 2017/0245467 A1
(43) Pub. Date: Aug. 31, 2017

(54) SYSTEM AND METHOD OF PET BEHAVIOR MODIFICIATION

(71) Applicant: Angela Lynn Greiner, Plano, TX (US)

(72) Inventor: Angela Lynn Greiner, Plano, TX (US)

(21) Appl. No.: 15/594,781

(22) Filed: May 15, 2017

Related U.S. Application Data
(63) Continuation-in-part of application No. 12/872,186, filed on Aug. 31, 2010, now Pat. No. 9,648,852.
(60) Provisional application No. 61/238,827, filed on Sep. 1, 2009.

(51) Int. Cl. A01K 15/02; A01K 1/035; A47C 31/00; E06B 9/00; A47G 9/00; A47G 27/02; E06B 7/28; A01M 29/12; A47C 31/10

(52) U.S. Cl. CPC A01K 15/02; A01M 29/12; A01K 1/035; A47C 31/005; A47C 31/10; A47G 9/007; A47G 27/0206; E06B 7/28; E06B 9/00

(57) ABSTRACT

A system and method of training or modifying the behavior of pets and, in particular, dogs is disclosed and may include using scratch-resistant protector having adhesive and/or additive to protect the integrity of a door or other object. The adhesive may generally provide a securing or coupling relationship between an object and protector. The additive may provide a material that canines find unpleasant to smell, taste, touch, and/or scratch. In some implementations, the additive may be reapplied (e.g., if it wears off and/or otherwise diminishes in strength, quantity, quality, and/or overall effectiveness).

### CROSS-REFERENCE TO RELATED APPLICATION

This application is a continuation in part of U.S. patent application Ser. No. 12/872,186, entitled “System and Method of Pet Behavior Modification” filed on Aug. 31, 2010 and now issued as U.S. patent Ser. No. ______, which claims the benefit of U.S. Provisional Patent Application 60/238,827 entitled “System and Method of Pet Behavior Modification” filed on Sep. 1, 2009, all of which are hereby incorporated by reference.

### TECHNICAL FIELD

The present invention relates to behavior modification of animals, such as pets.

### BACKGROUND

Various implementations include training systems and methods. In some implementations, the systems and methods may modify the behavior of an animal, such as a pet.

Pets, in particular dogs, tend to require training and behavior modification for a variety of reasons. For example, dogs are often kept indoors and require house training. Pet owners may use various disciplinary techniques to train pets such as, for example, confining the pet in a particular room or bathroom for a short period of time. When confined in a room, dogs tend to scratch and damage doors and other enclosures in an attempt to escape or get the owner's attention. Repairs to such doors and enclosures may be relatively expensive and bothersome especially if the repairs need to be made often.

What is needed is a system and method of training or modifying the behavior of pets to generally protect the integrity of doors and enclosures.

### SUMMARY

[[Note: once the claims have been finalized, this section will be amended to include language similar to the claims]]

In some implementations, a pet behavior modification system may include a covering and an additive associated with the covering. The covering may include an adhesive to couple the covering to a surface. The additive may have a deterrent effect on the pet.

One or more implementations may include the following features. The deterrent effect may include an unpleasant scent, an unpleasant taste, and/or an unpleasant texture. The deterrent effect may be activated when the covering is touched. The additive may be reapplied to the covering, for example, when the deterrent effect is diminished in strength (e.g., relative to the original deterrent effect of the additive on the covering). The additive may be disposed throughout the thickness of the covering, and/or disposed along at least a portion of one side of the covering. In some implementations, the surface may include a door surface, a couch surface, a table surface, rug surface, a slipcover surface, a sheet surface, other furniture surfaces, floor surface, and/or portions thereof. The adhesive may provide a temporary coupling and/or removable between the covering and the surface, in some implementations.

In some implementations, the pet behavior modification system may include a covering that includes an adhesive to removably couple the covering to a surface of a door. The system may also include an additive associated with the covering. The additive may have a deterrent effect to a pet. The additive may be activated when the covering is touched by the pet.

One or more implementations may include the following features. The deterrent effect may include an unpleasant scent, unpleasant texture, and/or an unpleasant taste. The additive may be reapplied to the covering, for example, when the deterrent effect diminished in strength. The additive may be disposed through the covering (e.g., through dispersed through a thickness of the covering).

In some implementations, a pet behavior modification system may include a covering that includes an adhesive to couple the covering to a surface of a door. The system may include an additive associated with the covering. The additive may release an unpleasant scent when the covering is touched by the pet.

One or more implementations may include the following features. The additive may be reapplied to the covering, for example, when the deterrent effect diminished in strength. The additive may be disposed through the covering (e.g., through dispersed through a thickness of the covering). In some implementations, the adhesive may removably couple the covering to the surface.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1A illustrates a top view of an implementation of an example covering.

FIG. 1B illustrates a cross-sectional view of an implementation of the example covering, illustrated in FIG. 1A.

FIG. 1C illustrates an implementation of an example system for canine behavior modification having a door protector.

FIG. 2 illustrates a cross-sectional view of an implementation of an example door protector having an adhesive layer.

FIG. 3 illustrates a cross-sectional view of an implementation of an example door protector having an additive.

FIG. 4 illustrates a cross-sectional view of an implementation of an example door protector having an adhesive and an additive.

FIG. 5 illustrates a cross-sectional view of an implementation of an example door protector having an additive dispersed throughout the thickness of the door protector.

FIG. 6 illustrates a cross-sectional view of an implementation of an example door protector having an adhesive and an additive dispersed through the door protector.

FIG. 7 illustrates a cross-sectional view of an implementation of an example door protector having an additive dispersed though the door protector and an additive layer disposed on a surface of the door protector.

FIG. 8 illustrates a cross-sectional view of an implementation of an example door protector having an adhesive, an additive dispersed through the door protector, and an additive layer disposed on a surface of the door protector.

FIG. 9 illustrates an implementation of an implementation of a process for using an example canine behavioral modification system.

FIG. 10 illustrates an implementation of an implementation of an example couch with the pet behavior modification system.

FIG. 11 illustrates an implementation of an implementation of an example flooring with the pet behavior modification system.

Like reference symbols in the various drawings indicate like elements.

### DETAILED DESCRIPTION

In various implementations, the described systems and methods may modify the behavior of pets (e.g., dogs). Modifying pet behavior may train the pet. For example, a pet may be trained to not scratch doors and/or other furniture, not jump on couches and/or other chairs, not scratch floors and/or other surfaces, etc. Thus, by providing a low cost, effective pet behavior system and associated method, user satisfaction with living with pets and pet training may be increased (e.g., relative to untrained pets).

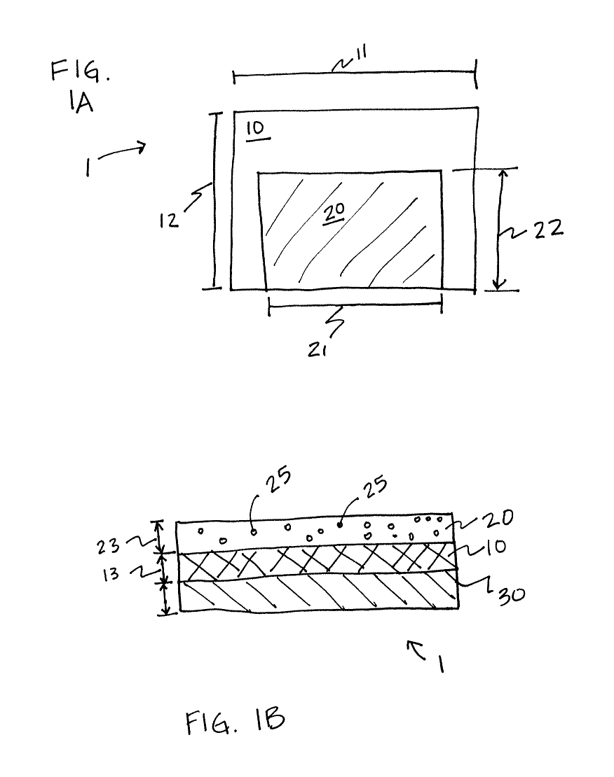

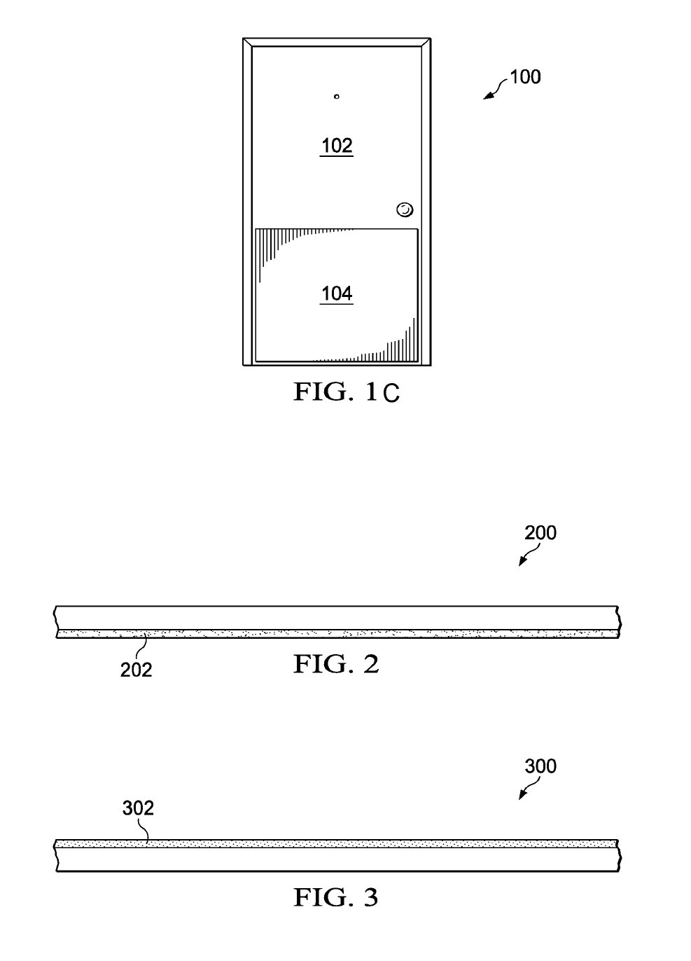

In various implementations, the pet behavior modification system may include a covering. The covering may include a substrate and an additive layer coupled to the substrate, in some implementations. FIG. 1A illustrates an implementation of the covering, and FIG. 1B illustrates a cross-sectional view of an implementation of the example covering, illustrated in FIG. 1A. The covering of the pet behavior modification system 1 may include a substrate 10 and an additive layer 20. The substrate may include any appropriate material such as a film (e.g., a plastic and/or other polymer film), a natural woven material (e.g., paper, cotton, jute, etc.), synthetic materials (e.g., vinyl, plastics, etc.), and/or any other appropriate substrate. The substrate may allow the additive layer to be dispersed through at least a portion of the substrate (e.g, mesh substrate, fiber substrate, penetrable substrate, etc.). The substrate 10 may have any appropriate length 11, any appropriate width 12, and any appropriate thickness 13. As illustrated, the substrate 10 may include a first side 15 and an opposing second side 16.

The additive layer 20 may be disposed on and/or coupled to at least a portion of the first side 15 of the substrate 10, in some implementations. The additive layer may be dispersed at least partially through the substrate (e.g., to form the covering). The additive layer 20 may have any appropriate length 21, any appropriate width 22, and any appropriate thickness 23. The additive layer may include additive. Additive may include any suitable concentration of deterrent, natural or organic deterrent, repellent, scent, citrus scent, citronella, foul-smelling material, herbal mixture, botanical material, oil, mineral, lotion, cream, sprayable material, other suitable deterrent, or any combination thereof in some implementations. In some implementations, additive may include a treated surface, touch-sensitive scented material, scratchable material, scratch-resistant material, grooved surface, other suitable tactile material, or any combination thereof.

As illustrated in FIG. 1B, the additive layer may include of additive 25 dispersed through at least a portion of the additive layer 20. The dispersion of the additive in the additive layer may be uniform and/or non-uniform.

The additive layer may or may not include more than one sublayer. For example, the additive layer may include first sublayer(s), second sublayer(s) that include the additive, and/or third sublayer(s). The second sublayer and/or the third sublayer may be disposed proximate the first side of the substrate. The first sublayer may facilitate inadvertent release upon light touching (e.g., touching than applies less than a predetermined force) and/or tasting. For example, the additive may be released when the first sublayer is broken. In some implementations, the additive layer may be dispersed throughout the additive layer.

The additive may include any appropriate additive that has a deterrent effect on a pet. In some implementations, the deterrent effect may be for a first period of time, and after the first period of time the deterrent effect may be inactivated. For example, the unpleasant scent and/or unpleasant taste may diminish such that the unpleasant scent and/or unpleasant taste is not unpleasant. The deterrent effect may be reactivated by later scratches and/or touches by a pet. The additive may not be activated unless the additive layer (e.g., a layer that includes additive) is touched and/or scratched by the pet. In some implementations, the pet must apply a predetermined force prior to releasing the additive. For example, the additive layer may be configured such that scratching and/or other touches that apply greater than a predetermined force (e.g., biting, rubbing hard against, etc.) may release the additive from the additive layer and/or light touches (e.g., a pet passing by a piece of furniture) may not release the additive from an additive layer. In some implementations, the additive may be released (e.g., not activated) by a pet licking and/or otherwise tasting the additive layer. For example, the adhesive may not be activated by light touches (e.g., touches less than a predetermined force such as scratching) and so tasting may not activate the release of adhesive from the adhesive layer.

The pet behavior modification system may or may not include an adhesive layer 30. The adhesive layer may be disposed on at least a portion of the second side 16 of the substrate 10 (e.g., to form an adhesive covering). The adhesive layer may include any appropriate adhesive. The adhesive may be temporary, removable, and/or repositionable. For example, the adhesive layer may allow a user to remove the covering (e.g., uncouple the covering) from a first location to which the covering is coupled, and reposition and couple the covering at a different location (e.g., overlapping and/or not overlapping with the first location). User costs associated with use and/or ease of use may be increased by providing coverings with removable and/or repositionable adhesive layers.

The layers of the pet behavior modification system may be coupled together by any appropriate manner (e.g., screen printing, ink printing, adhesives, fasteners, bonding, etc.). In some implementations, one or more layers may be replaceable. For example, new adhesive layer(s) and/or additive layer(s) may be coupled to the covering (e.g., on top of the existing adhesive layer and/or additive layer). In some implementations, at least a portion of existing adhesive layer(s) and/or additive layer(s) may be removed prior to coupling new adhesive layer(s) and/or additive layer(s) to the covering. Allowing replacement of the adhesive layer and/or additive layer may decrease overall costs for a lifetime of the product, increase user satisfaction, and/or decrease the environmental footprint of the product.

In some implementations, the pet behavior modification system and/or portions thereof (e.g., substrate and/or covering) may be clear, transparent, and/or translucent. User aesthetics may be increased by utilizing clear, transparent, and/or translucent pet behavior modification system or portions thereof. For example, the pet behavior modification system may be less visible to users on flooring and/or furniture if it is clear, transparent, and/or translucent. In some implementations, the pet behavior modification system or portions thereof may include embellishments (e.g., for easy identification, more seamless blending with an object to which it is coupled, and/or to make the pet behavior modification system more fanciful and/or increase aesthetics to some users).

In various implementations, the described pet behavior modification system may be utilized in a variety of applications. In some implementations, the covering of the pet behavior modification may be coupled to another object. For example, the pet behavior modification system (e.g., the covering) may be mounted on doors as a door protector (e.g., to inhibit pet behavior of door scratching). The pet behavior modification system may be coupled to furniture of portions thereof (e.g., couch, chair, furniture legs, etc.). The pet behavior modification system may be applied to portions of a residence and/or venue (e.g., public or private), such as walls, windows, widow sills, baseboards, railing, and/or portions thereof. In some implementations, the pet behavior modification system may be applied to flooring, such as hardwood flooring, tile flooring, composition flooring, concrete flooring, and/or portions thereof. In some implementations, covering may be applied to flooring proximate an area that is restricted to pet access and/or in combination with coverings applied to other objects. For example, the pet behavior modification system may be applied on the floor proximate a door that includes the pet behavior modification system and/or furniture that includes the pet behavior modification system. The additional use of the pet behavior modification system on the floor in combination with other applications of the pet behavior modification system may increase the speed of pet behavior modification, in some implementations.

In some implementations, the covering may not be coupled to another object. For example, the covering may be used as a rug (e.g., the rug and/or portions thereof such as a border), slipcover (e.g., for a sofa and/or chair), a bed (e.g., blanket, duvet, etc.), pillow, sheet, or portions thereof.

In some implementations, the pet behavior modification system may include using a scratch-resistant door protector having an adhesive, additive, or both to protect the integrity of the door. The adhesive may generally provide a securing or coupling relationship between the door and the protector, while the additive may provide a material that canines find unpleasant to smell, taste, touch, or scratch. In some implementations, the additive may be reapplied if the additive wears off or otherwise diminishes in strength, quantity, quality, or overall effectiveness.

FIG. 1A is an exemplary illustration of a pet or canine behavior modification system 100 in some implementations. It should be understood that system 100 shown in FIG. 1A is for illustrative purposes only and that any other suitable system or subsystem may be used in conjunction with or in lieu of system 100 in some implementations.

System 100 may include door 102 and protector 104 in some implementations. Door 102 may include a track operated door, a trackless door, an overhead door, a sectional door, a rolling door, a roll-up door, a swing door, a panel door, a retractable door, a collapsible door, a canopy-like door, a ball-bearing door, a sliding door, a magnetic door, a push-pull door, a rack and pin controlled door, a remote controlled door, a car door, a car seat, a wall, a drywall, a movable wall, a movable window, a movable panel, a piece of furniture, a floor, a window sill, a ledge, a countertop, a table top, a curtain, a divider, a controllable opening, a configurable aperture, other door-like apparatus, or any suitable combination thereof.

In FIG. 1A, door 102 is shown in a generally fully closed position. Door 102 may, however, be moved or otherwise repositioned to a fully opened, semi-open, semi-closed, fully closed, locked, secured, other position or disposition, or any suitable combination thereof to allow the pet to use door 102 to enter or exit through door 102. Although door 102 is generally illustrated as a rectangular shaped structure in FIG. 1A, it should be understood that any suitable shape, size, thickness, material, or configuration for door 102 may be utilized, as appropriate.

In some implementations, door protector 104 may generally be secured or otherwise coupled to door 102 and provide door 102 protection from scratches, marks, or other forms of disfigurement caused by pets and, in particular, canines. Door protector 104 may be secured or otherwise coupled with any suitable surface of door 102 including, for example, a surface that includes glass, wood, metal, plastic, any suitable material, or any combination thereof. In some implementations, door protector 104 may be secured or otherwise coupled to a smooth, grooved, beveled, painted, coated, sealed, or treated surface of door 102 in some implementations.

In some implementations, door protector 104 may include nylon, polyurethane, polyethylene, polyvinyl chloride (PVC), polytetrafluoroethylene (PTFE), polyester, high-gloss polyester, laminate, synthetic rubber, natural rubber, plastic, plexiglass, polymer, other suitable materials, or any combination thereof.

Door protector 104 may include any number of suitable coatings, layers, or additives to an entire surface, layer, sub-layer, or structure of door protector 104 or to a portion of a surface, layer, sub-layer, or structure of door protector 104 in some implementations, for example as illustrated FIGS. 2-8 described in detail later herein.

In some implementations, door protector 104 may be made of a clear material, a colored material, or any appropriate material to enhance or otherwise suit the décor of door 102 or the room (or other enclosure or area) associated with door 102. In some implementations, door protector 104 may be embellished with different colors, stickers, removable stickers, paints, stencils, erasable markers, chalks, designs, patterns, images, wood grain patterns, novelty items, ornamental items, other decorative materials, or any combination thereof. For example, user satisfaction may be increased by providing the door protector with different embellishments. In some implementations, these embellishments may deter the pet from approaching, touching, or scratching door 102.

Door protector 104 may be cut, reconfigured, or otherwise resized to custom fit door 102 or portions of door 102 in some implementations. For example, door protector 104 may be customized to any suitable shape, size, thickness, or configuration, as appropriate. In some implementations, door protector 104 may be placed over a lower portion of a surface of door 102 as shown in FIG. 1A. It should be understood, however, that door protector 104 may cover any suitable portion of door 102, two or more surfaces of door 102, two or more portions of door 102, or an entire surface of door 102.

FIG. 2 is an exemplary cross-sectional view of door protector 200 having adhesive 202 in some implementations. It should be understood that door protector 200 shown in FIG. 2 is for illustrative purposes only and that any other suitable system or subsystem may be used in conjunction with or in lieu of door protector 200 in some implementations.

Door protector 200 shown in FIG. 2 may be similar to door protector 104 shown in FIG. 1A and described in conjunction with the description accompanying FIG. 1A herein. Although specific implementations of door protector 200 have been described the door protector may include any shape, size, thickness, configuration, and/or include any embellishments as described above with door protector 104, as appropriate

Adhesive 202 may be disposed on or otherwise coupled to door protector 200 in some implementations. Adhesive 202 may be a layer, part of a layer, sub-layer, strip, a discrete portion of door protector 200, or entire thickness of door protector 200 to generally aid in securing door protector 200 to a door such as, for example, door 102 shown in FIG. 1A. Adhesive 202 may include a material conducive to providing a static cling property between door protector 200 and door 102 in some implementations. Adhesive 202 may also include tape, glue, temporary adhesive, hook-and-loop fastener, removable adhesive tab, peel-and-stick materials, spray adhesive, heat sensitive adhesive, clay, putty, sticky material, staples, retaining structures, clips, screws, pins, other suitable adhesive or retaining devices, or any combination thereof.

FIG. 3 is an exemplary cross-sectional view of door protector 300 having additive 302 in some implementations. It should be understood that door protector 300 shown in FIG. 3 is for illustrative purposes only and that any other suitable system or subsystem may be used in conjunction with or in lieu of door protector 300 in some implementations.

Door protector 300 shown in FIG. 3 may be similar to door protector 104 shown in FIG. 1A and described in conjunction with the description accompanying FIG. 1A herein. Although one implementation has been described, the door protector 300 may also be customized to any suitable shape, size, thickness, or configuration and include any embellishments as described above with door protector 104, as appropriate.

Additive 302 may be impregnated or dispersed in a layer, part of a layer, sub-layer, strip, a discrete portion of door protector 200, or entire thickness of door protector 200 to generally aid in securing door protector 200 to a door such as, for example, door 102 shown in FIG. 1A. Additive 302 may include any appropriate additive to help train a pet. For example, additive 302 may include any foul or unpleasant tasting or smelling material, or any material or combination of materials that pets generally find unpleasant to touch or scratch. In some implementations, additive 302 may be a spray-on or otherwise reapplied if additive 302 wears off or otherwise diminishes in strength, quantity, quality, or overall effectiveness.

Additive 302 may include any suitable concentration of deterrent, natural or organic deterrent, repellent, scent, citrus scent, citronella, foul-smelling material, herbal mixture, botanical material, oil, mineral, lotion, cream, sprayable material, other suitable deterrent, or any combination thereof in some implementations. In some implementations, additive 302 may include a treated surface, touch-sensitive scented material, scratchable material, scratch-resistant material, grooved surface, other suitable tactile material, or any combination thereof.

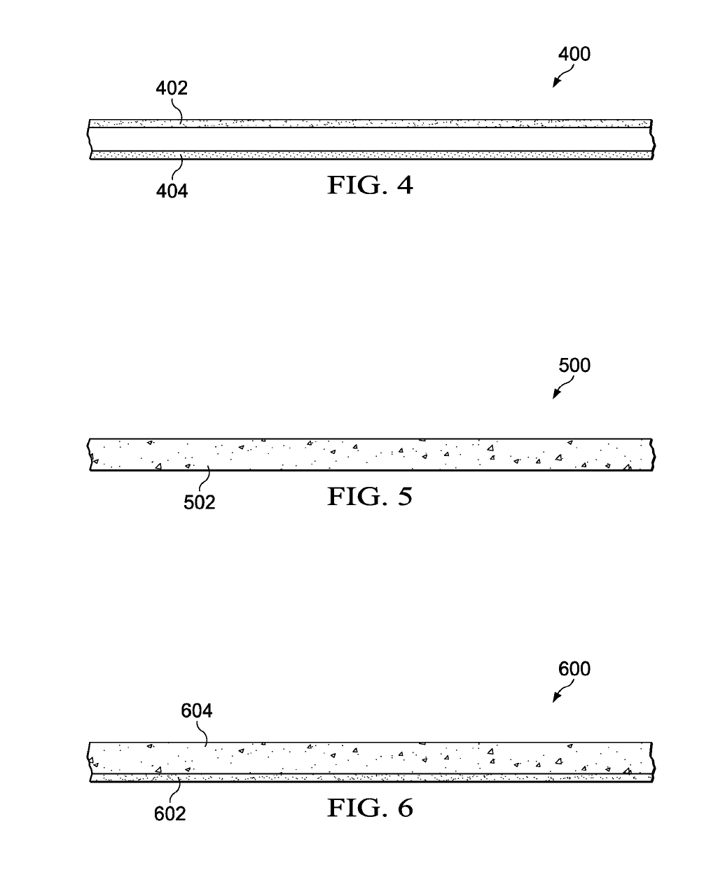

FIG. 4 is an exemplary cross-sectional view of door protector 400 having adhesive 402 and additive 404 in some implementations. It should be understood that door protector 400 shown in FIG. 4 is for illustrative purposes only and that any other suitable system or subsystem may be used in conjunction with or in lieu of door protector 400 in some implementations.

Door protector 400 shown in FIG. 4 may be similar to door protector 104 shown in FIG. 1A and described in conjunction with the description accompanying FIG. 1A herein. Although specific implementations of door protector 400 have been described the door protector may include any shape, size, thickness, configuration, and/or include any embellishments as described above with door protector 104, as appropriate

Adhesive 402 may be similar to adhesive 202 shown in FIG. 2 and described in conjunction with the description accompanying FIG. 2 herein. Likewise, additive 404 may be similar to additive 302 shown in FIG. 3 and described in conjunction with the description accompanying FIG. 3 herein.

FIG. 5 is an exemplary cross-sectional view of door protector 500 having additive 502 in some implementations. It should be understood that door protector 500 shown in FIG. 5 is for illustrative purposes only and that any other suitable system or subsystem may be used in conjunction with or in lieu of door protector 500 in some implementations.

Door protector 500 shown in FIG. 5 may be similar to door protector 104 shown in FIG. 1A and described in conjunction with the description accompanying FIG. 1A herein. Although specific implementations of the door protector 500 have been described, the door protector may be any suitable shape, size, thickness, or configuration and include any embellishments as described above with door protector 104, as appropriate.

Additive 502 may be generally dispersed through the thickness of door protector 500 and may be similar to additive 302 shown in FIG. 3 and described in conjunction with the description accompanying FIG. 3 herein.

FIG. 6 is an exemplary cross-sectional view of door protector 600 having adhesive 602 and additive 604 in some implementations. It should be understood that door protector 600 shown in FIG. 6 is for illustrative purposes only and that any other suitable system or subsystem may be used in conjunction with or in lieu of door protector 600 in some implementations.

Door protector 600 shown in FIG. 6 may be similar to door protector 104 shown in FIG. 1A and described in conjunction with the description accompanying FIG. 1A herein. Although specific implementations of the door protector 600 have been described, the door protector may include any shape, size, thickness, or configuration and include any embellishments with door protector 104, as appropriate.

Adhesive 602 may be similar to adhesive 202 shown in FIG. 2 and described in conjunction with the description accompanying FIG. 2 herein. Likewise, additive 604 may be similar to additive 302 shown in FIG. 3 and described in conjunction with the description accompanying FIG. 3 herein.

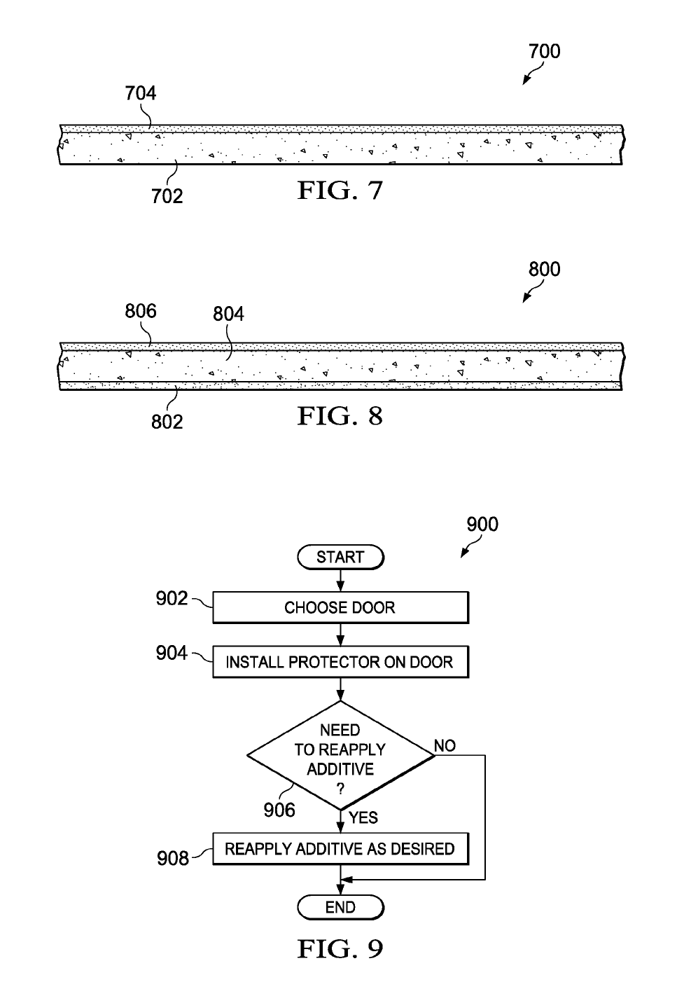

FIG. 7 is an exemplary cross-sectional view of door protector 700 having additive 702 and additive 704 in some implementations. It should be understood that door protector 700 shown in FIG. 7 is for illustrative purposes only and that any other suitable system or subsystem may be used in conjunction with or in lieu of door protector 700 in some implementations.

Door protector 700 shown in FIG. 7 may be similar to door protector 104 shown in FIG. 1A and described in conjunction with the description accompanying FIG. 1A herein. Although specific implementations of door protector 700 have been described the door protector may include any shape, size, thickness, configuration, and/or include any embellishments as described above with door protector 104, as appropriate.

Additive 702 and additive 704 may be similar to additive 302 shown in FIG. 3 and described in conjunction with the description accompanying FIG. 3 herein. In some implementations, additive 702 may be generally dispersed through the thickness of door protector 500, while additive 704 may be generally disposed in a layer-like fashion over a surface of door protector 500.

FIG. 8 is an exemplary cross-sectional view of door protector 800 having adhesive 802, additive 804, and additive 806 in some implementations. It should be understood that door protector 800 shown in FIG. 8 is for illustrative purposes only and that any other suitable system or subsystem may be used in conjunction with or in lieu of door protector 800 in some implementations.

Door protector 800 shown in FIG. 8 may be similar to door protector 104 shown in FIG. 1A and described in conjunction with the description accompanying FIG. 1A herein. Although specific implementations of door protector 800 have been described the door protector may include any shape, size, thickness, configuration, and/or include any embellishments as described above with door protector 104, as appropriate

Adhesive 802 may be similar to adhesive 202 shown in FIG. 2 and described in conjunction with the description accompanying FIG. 2 herein. Additive 804 and additive 806 may be similar to additive 302 shown in FIG. 3 and described in conjunction with the description accompanying FIG. 3 herein. In some implementations, additive 804 may be generally dispersed through the thickness of door protector 800, while additive 806 may be generally disposed in a layer-like fashion over a surface of door protector 800.

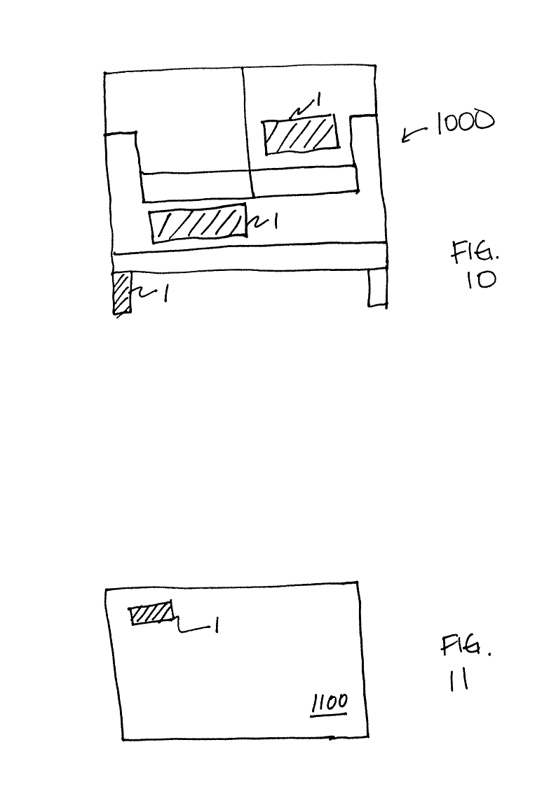

FIG. 9 is a somewhat simplified flow diagram illustrating method 900 of using a behavioral modification system in some implementations. It should be understood that method 900 shown in FIG. 9 is for illustrative purposes only and that any other suitable method or sub-method may be used in conjunction with or in lieu of method 900 in some implementations. It should also be understood that the steps of method 900 may be performed in any suitable order or manner.

In some implementations, step 902 may include a user of a pet behavioral modification system such as, for example, system 100 shown in FIG. 1A, choosing a door such as, for example, door 102 also shown in FIG. 1A, to implement system 100.

After choosing door 102, a door protector such as, for example, door protector 104 shown in FIG. 1A, may be installed on door 102 in step 904. The installation may depend on the type of adhesive used with door protector 104. For example, the adhesive used in step 904 may include adhesive 202 shown in FIG. 2 and described in the description accompanying FIG. 2 herein.

In step 906, the user ascertains whether an additive associated with door protector 104 needs replenishing or reapplication. If the amount of additive such as, for example, additive 302 shown in FIG. 3 and described in the description accompanying FIG. 3 herein, is inadequate, the user may reapply additive 302 in step 908. For example, additive 302 may be sprayed on a surface of door protector 104 to increase the strength or effectiveness of additive 302. Otherwise, if the user ascertains that no additional additives are required in step 906, then method 900 ends.

Although several implementations have been described in terms of door protection, one or more of the described features may be utilized with other applications of the pet behavior modification system. For example, as illustrated in FIG. 10, the pet behavior modification system may be utilized with a couch. A couch 1000 may include a pet behavior modification system 1 that includes an additive layer. For example, the entire couch or portions thereof (e.g., arms, legs, seat cushions, backs, skirts, etc.), as illustrated, might include the pet behavior modification system (e.g., coupled to a surface of the couch or portions thereof). As illustrated in FIG. 11, the pet behavior modification system may be utilized on flooring. The flooring 1100 may include a pet behavior modification system 1 that includes a covering 10 and an additive layer. The pet behavior modification system 1 may or may not be coupled to the flooring 1100 via an adhesive layer of the pet modification system. The pet modification system 1 may act as a rug in some implementations. For example, the covering may include jute or another material appropriate to form a rug. The additive layer may be dispersed on the top and/or side surfaces of the rug and/or portions thereof (e.g., border or portions thereof, area proximate a restricted area such as a door or room, etc.).

Although the pet behavior modification system has been described in terms of pets such as dogs, the behavior of other pets (e.g., cats and/or other animals that bite, scratch, or are capable of applying greater than a predetermined force to surfaces) may be modified.

Although users have been described as a human, a user may be a person or a group of people.

Various described processes or portions thereof may be implemented by various described pet behavior modification systems. In some implementations, various operations may be added, deleted, and/or modified. In some implementations, described processes may be performed in combination with other processes or portions thereof.

It is to be understood the implementations are not limited to particular systems or processes described which may, of course, vary. It is also to be understood that the terminology used herein is for the purpose of describing particular implementations only, and is not intended to be limiting. For example, the term coupling describes direct and indirect coupling, unless the content clearly indicates otherwise. As used in this specification, the singular forms “a”, “an” and “the” include plural referents unless the content clearly indicates otherwise. Thus, for example, reference to “an additive” includes a combination of two or more additives and reference to “a covering” includes different types and/or combinations of coverings.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular implementaitons of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding implementaitons described herein may be utilized according to the present disclosure. Accordingly, the appended claims are intended to include within their scope such processes, machines, manufacture, compositions of matter, means, methods, or steps.

1. A pet behavior modification system comprising:
a substrate comprising a first side and an opposing second side;
an additive layer coupled to at least a portion of the substrate, wherein the additive layer comprises an additive that has a deterrent effect on a pet, wherein activation of the deterrent effect of additive is inhibited unless a pet scratches or touches the additive layer.

2. The pet behavior modification system of claim 1 wherein at least a portion of the substrate is at least one of clear, transparent, or translucent.

3. The pet behavior modification system of claim 1 wherein the additive layer is dispersed through the substrate.

4. The pet behavior modification system of claim 1 wherein the additive layer is disposed proximate the first side of the covering.

5. The pet behavior modification system of claim 1 wherein the additive comprises more than one additive.

6. The pet behavior modification system of claim 1 wherein the deterrent effect comprises at least one of an unpleasant smell, an unpleasant taste, or an unpleasant texture.

7. The pet behavior modification system of claim 1 further comprising a covering, wherein the covering comprises the substrate and the additive layer, and wherein the covering comprises at least one of:
at least a portion of a slipcover,
at least a portion of a sheet, or
at least a portion of a rug.

8. The pet behavior modification system of claim 1 wherein the additive layer is reapplicable to the substrate.

9. The pet behavior modification system of claim 1 wherein the activation of the deterrent effect of the additive is inhibited by touches by a pet less than a predetermined force by the pet.

10. A pet behavior modification system comprising:
a substrate comprising a first side and an opposing second side;
an additive layer disposed proximate the first side of the substrate and coupled to the first side of the covering, wherein the additive layer comprises an additive that has a deterrent effect on a pet, wherein the deterrent effect of additive is inactive until a pet scratches or touches the additive layer; and
an adhesive layer coupled to the second side of the substrate.

11. The pet behavior modification system of claim 10 wherein the adhesive layer is adapted to allow the pet behavior modification system of claim 7 to be repositionable.

12. The pet behavior modification system of claim 10 wherein at least one of the additive layer and/or adhesive layer is reapplicable to the substrate.

13. The pet behavior modification system of claim 10 wherein the adhesive layer comprises a temporary coupling between the pet behavior modification system and an object to which the pet behavior modification system is coupled.

14. The pet behavior modification system of claim 10 wherein the deterrent effect comprises at least one of an unpleasant smell, an unpleasant taste, or an unpleasant texture.

15. The pet behavior modification system of claim 1 further comprising a covering, wherein the covering comprises the substrate, the additive layer, and the adhesive layer; and wherein the covering is coupled to at least one of:
at least a portion of a door,
at least a portion of a wall,
at least a portion of a window sill,
at least a portion of a flooring,
at least a portion of furniture,
at least a portion of a couch,
at least a portion of a chair,
at least a portion of a slipcover,
at least a portion of a sheet, or
at least a portion of a rug.

16. The pet behavior modification system of claim 10 wherein at least a portion of the substrate is at least one of clear, transparent, or translucent.

17. The pet behavior modification system of claim 10 wherein the deterrent effect is not activated the pet tasting the pet behavior modification system.

18. The pet behavior modification system of claim 10 wherein activating the deterrent effect of the additive layer comprises releasing the additive from the additive layer.

19. The pet behavior modification system of claim 10 wherein the deterrent effect is activated for a first period of time when the pet scratches or touches the additive layer, and wherein the deterrent effect is deactivated after the first period of time elapses.

20. The pet behavior modification system of claim 19, wherein the deterrent effect is reactivated by a subsequent touch or scratch by the pet.
